(19) United States
(12) Patent Application Publication
(10) Pub. No.: US 2026/0219197 A1
(43) Pub. Date: Jul. 30, 2026

(54) TOOLING AND METHOD FOR VISUALLY INSPECTING AN AIRCRAFT TURBOMACHINE PART

(71) Applicant: SAFRAN AIRCRAFT ENGINES, Paris (FR)

(72) Inventors: Thomas Laurent Frédéric GAUDUCHON, MOISSY-CRAMAYEL (FR); Joris Jean-Emmanuel Johann LECOMTE, MOISSY-CRAMAYEL (FR); Antoine Frédéric Jean SATRE, MOISSY-CRAMAYEL (FR)

(73) Assignee: SAFRAN AIRCRAFT ENGINES, Paris (FR)

(21) Appl. No.: 19/146,150

(22) PCT Filed: Jan. 8, 2024
(86) PCT No.: PCT/FR2024/050016

§ 371 Date: Jul. 7, 2025

(30) Foreign Application Priority Data
Jan. 12, 2023 (FR) FR2300314

(51) Int. Cl. G01N 21/88

(52) U.S. Cl. CPC G01N 21/8803

(57) ABSTRACT

Tooling is configured for visually inspecting an aircraft turbomachine part that has an annular shape about an axis (X) and an annular attachment flange oriented in a radial direction with respect to the axis (X). The tooling includes an integrally formed body and a U-shaped hook configured to be mounted on the flange. The hook has two lateral branches configured to be located on both sides of the flange, respectively, and a frame connected to the hook and configured to cover a section of the part to be inspected. The frame defines a window through which an operator can view a portion of the section.

### TECHNICAL FIELD OF THE INVENTION

This invention relates to a tooling and a method for visually inspecting an aircraft turbomachine part.

### PRIOR ART

The technical background comprises documents with remote teachings such as U.S. Pat. No. 4,507,869.

There are several techniques for inspecting an aircraft turbomachine part, but the present invention concerns a visual inspection, i.e. an inspection carried out by a specialist operator or technician. This type of inspection can be carried out after the part has been manufactured or during a maintenance operation on the part or the turbomachine comprising this part.

During a visual inspection of a part, the operator must look for any defects on the part, i.e. marks or wear. Depending on a number of criteria, such as the type of marks or wear, their dimensions, position, etc., the operator must determine whether or not these marks or wear are acceptable. If there are no marks or wear on a part, it could be used or reused in a turbomachine. If there are marks or signs of wear on a part, it may be discarded or undergo a rectification operation.

The present invention concerns the inspection of an annular part, i.e. a part that has an annular shape around an axis. This part comprises an annular attachment flange which is oriented radially with respect to the axis. A attachment flange can be scalloped or non-scalloped and generally comprises a series of axial orifices through which attachment elements of the screw-nut type or similar can pass.

This annular part fitted with a radial flange can form, for example, a journal, casing, cowling, shell, wall, disc, etc., in the turbomachine.

The aim of the present invention is to provide a solution for visually checking an annular part of this type in a simple, effective and economical way.

### SUMMARY OF THE INVENTION

The invention relates to a tooling for visual inspecting an aircraft turbomachine part, this part having an annular shape around an axis and comprising an annular attachment flange which is oriented in the radial direction with respect to the axis, the tooling comprising an integrally formed body and comprising:
a U-shaped hook configured to be mounted on said flange, this hook comprising two lateral legs configured to be located on both sides of the flanges, respectively, and
a frame connected to the hook and configured to cover a portion to be inspected of the part, this frame defining a window through which an operator can view a segment of said portion.

The invention thus offers a simple, easy-to-use tooling that essentially comprises two portions: a hook and a frame. The hook is used to mount the tooling on the part to be inspected, this hook being configured to cooperate with the flange of this part. As the flange is subject to defects, one of the advantages of the hook is that it allows defects on the flange to be hidden and therefore allows defects (previously detected by the operator) in this area to be indicated as being located on the flange, which can be problematic. The frame covers a portion of the part and its window allows the operator to see a portion of the part through the tooling. Unlike the hook, which hides defects on the flange, any defects present on the rest of the part (apart from its flange) are either visible through the window or hidden by the frame. Depending on the position of the defects, they may be hidden by the tooling or visible through the tooling. The tooling can therefore be used to hide or reveal defects. More specifically, the tooling enables defects to be positioned precisely in order to determine their criticality for the part.

The tooling according to the invention is advantageously adapted for use on parts of different shapes and sizes. In addition, it can be easily moved around a part and from one part to another, thanks to its simplicity and lightness.

The tooling according to the invention may comprise one or more of the following characteristics, taken alone or in combination with each other:
the U-shaped hook has a generally curved shape and has a curvature configured to be similar to that of said flange;
the two legs of the hook are connected together by a bridge which has a generally curved shape and is configured to bear radially on the flange;
at least one of said legs comprises a bearing projection configured to bear on one side of the flange;
the frame comprises a bearing projection configured to bear on said portion of the part;
the frame has a generally curved shape;
the frame is inclined with respect to the hook;
the frame comprises two curved profiles, one internal and one external respectively, the circumferential ends of which are connected to one another by lateral uprights, these profiles and uprights delimiting between them said window;
the internal profile has a dimension, in particular a radial dimension, greater than that of the external profile, and greater than a circumferential thickness of each of the lateral uprights;
the frame comprises at least one edge, in particular on the inside of said window, forming a tracing rule on the part;
said at least one edge is selected from an external edge of the internal profile, an internal edge of the external profile, and a lateral edge of each of the lateral uprights;
the body has a generally curved shape and an angular extent of between 1° and 30° about an axis, which is configured to coincide with the axis of the part;
the body is made of a plastic material, such as TPU.

The present invention also relates to a method for visual inspecting an aircraft turbomachine part, by means of tooling as described above, the part having an annular shape about an axis and comprising an annular attachment flange which is oriented in the radial direction with respect to the axis, the method comprising the steps consisting of:
a) positioning the body of the tooling on the part by mounting the hook on the flange, the two lateral legs of the hook being located respectively on the two sides of the flange, and
b) inspecting the part, and in particular the portion of the part on which the body is mounted, this inspection step being carried out by an operator.

The method according to the invention may comprise one or more of the following characteristics or steps, taken alone or in combination with one another:
the part is a trunnion which comprises a frusto-conical wall, and said flange is directed radially towards the outside and located at the external periphery of the frusto-conical wall, the body of the tooling being positioned in step a) so that its frame is mounted on a portion of an external frusto-conical surface of that frusto-conical wall;
the hook axially clamps on the flange at the end of step a), the frame bearing on or being at a distance from the part;
the hook bears radially on the flange at the end of step a);
step b) comprises the sub-steps of:
checking by the operator if there are any marks or wear on the part which are hidden by the body of the tooling, and
checking by the operator if there are any marks or wear visible through the window of the tooling;
more particularly, step b) comprises the sub-steps of:
checking by the operator if there are any marks or wear on the part which are hidden by the frame, and in particular by its internal profile,
checking by the operator if there are any marks or wear on the part which are hidden by the hook,
checking by the operator if there are any marks or wear visible through the window;
at least one line is drawn on the part along one of the edges of the frame;
after steps a) and b), the method comprises a step c) of moving the body of the tooling on the part, by rotating the body mounted on the part about the axis of the part, then step b) is repeated;
the steps b) and c) are repeated as many times as necessary to inspect the entire contour of the part;
the flange is scalloped and/or comprises axial orifices for the passage of attachment elements of the screw-nut type, for example.

### BRIEF DESCRIPTION OF THE FIGURES

Further characteristics and advantages of the invention will become apparent from the following detailed description, for the understanding of which reference is made to the attached drawings wherein:

FIG. 1 is a schematic partial perspective view of an annular part to be inspected of an aircraft turbomachine;

FIG. 2 is a larger scale view of a portion of FIG. 1;

FIG. 3 is an axial sectional view of the part shown in FIG. 1;

FIG. 4 is a similar view to FIG. 2 and shows an inspection tooling according to one embodiment of the invention, which is mounted on the part to be inspected;

FIG. 5 is a cross-sectional view along line V-V of FIG. 4;

FIG. 6 is a larger-scale view of a detail from FIG. 5;

FIG. 7 is a larger-scale view of a further detail of FIG. 5; and

FIG. 8 is a view similar to FIG. 4 and illustrating a control process according to the invention.

### DETAILED DESCRIPTION OF THE INVENTION

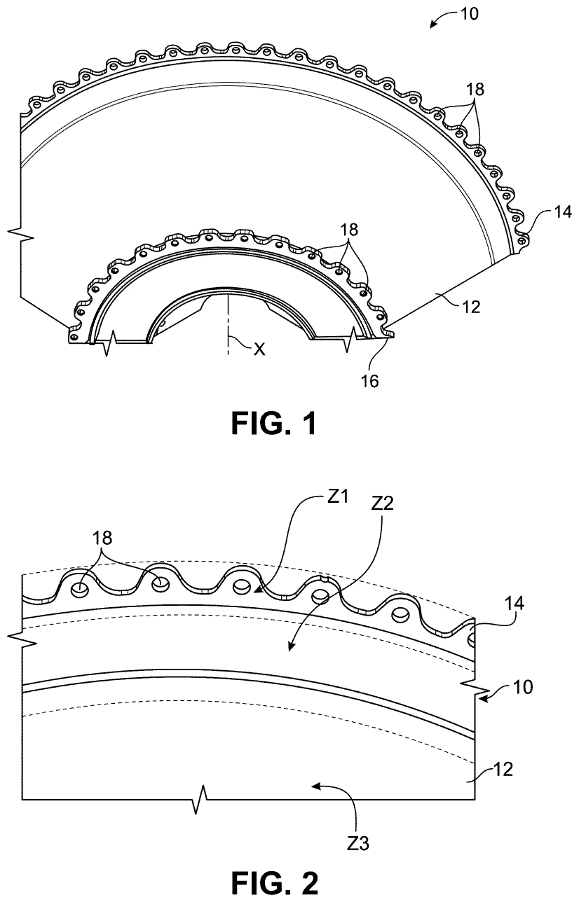

FIG. 1 shows a part 10 for an aircraft turbomachine.

This part 10 has an annular shape around an axis X, which is generally the longitudinal axis of the turbomachine.

In the example shown, the part 10 is a trunnion, although this example is not restrictive.

The part 10 comprises an annular wall 12 and an annular flange 14 which extends in a radial direction with respect to the axis X and which is located at the external periphery of the wall 12 in the example shown.

FIG. 1 also shows that part 10 comprises a further annular flange 16 extending radially from the internal periphery of the wall 12.

In the example shown, the wall 12 is solid and therefore has no orifices or openings, although this aspect is not restrictive. The flange 14 and the other flange 16 are scalloped but could alternatively be non-scalloped. Furthermore, in the example shown, the wall 12 has a frusto-conical shape. The flanges 14, 16 comprise axial orifices 18 for the passage of attachment elements of the screw-nut type or similar. Each of the scallops comprises an orifice 18 in the example shown. The orifices 18 in each flange 14, 16 are evenly spaced around the axis X.

FIG. 2 is a larger-scale view of a detail from FIG. 1 and shows three separate annular control zones Z1, Z2 and Z3 on the part 10.

The zone Z1 is located at flange 14. Any marks or wear in this zone Z1 are not acceptable for the part 10. It is therefore important that the part 10 is free from such defects in this zone Z1.

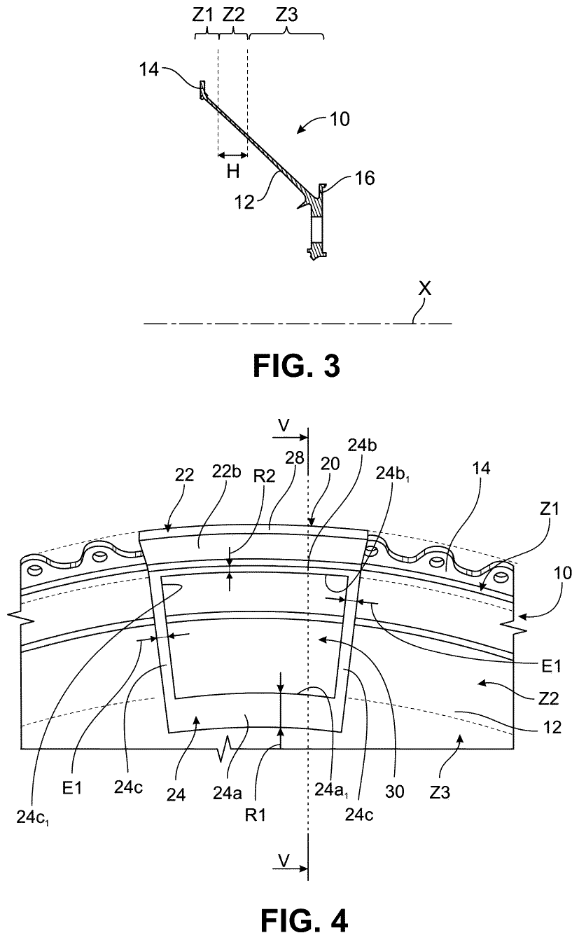

The zone Z2 extends from the zone Z1 to the zone Z3 and has a predetermined axial dimension H, measured from the flange 14 (see FIG. 3). Any marks or wear in this zone Z2 are potentially problematic for the part 10. It is therefore important to be able to detect any defect in this zone Z2 in order to be able to better characterize this defect, and for example measure its dimensions.

The zone Z3 extends between the zone Z2 and the internal periphery of the part 10. Any marks or wear in this zone Z3 are less of a problem for the part 10. It is therefore important to be able to locate a fault between this zone Z3 and the surrounding zone Z2.

The tool according to the invention enables this type of the part 10 to be inspected and makes it easier to locate any defects in the various zones Z1, Z2 and Z3.

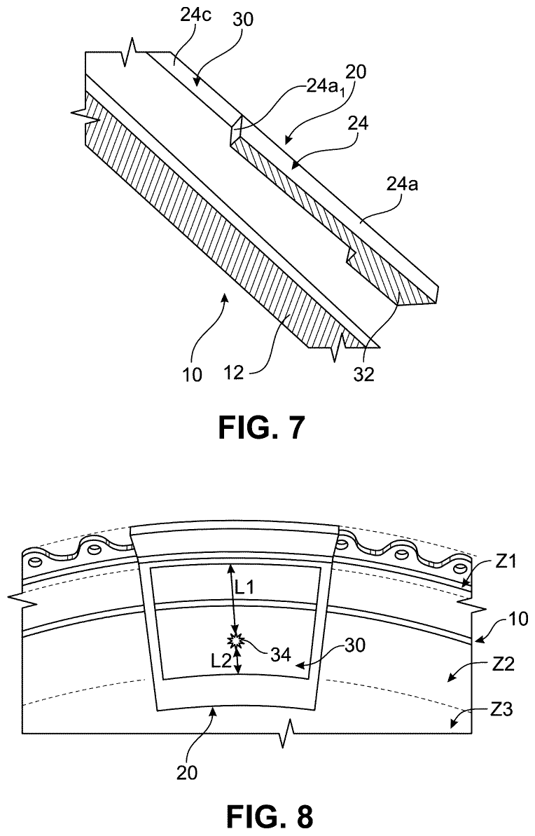

FIGS. 4 to 8 illustrate an embodiment of this tooling 20.

The tooling 20 comprises a body formed in one-part. This tooling 20 is designed to be mounted on the part 10 to be inspected and is preferably made from a material that is not likely to damage the part 10 by impact or friction. The body of the tooling 20 is advantageously made of a plastic material such as TPU (thermoplastic polyurethane). It can be produced using additive manufacturing. The part 10 to be inspected is generally made of a metal alloy The body of the tooling 20 essentially comprises two portions: a hook 22 and a frame 24.

In the example shown, the body of the tooling 20 has a generally curved shape about the axis X when mounted on the flange 14.

For example, the body has an angular extent of between 10 and 30° around the axis X when the body is mounted on the part 10.

The hook 22 is a U-shaped hook which is configured to be mounted on the flange 14, as can be seen in FIGS. 4 to 6 for example.

The hook 22 comprises two lateral legs 22a, 22b configured to be located axially on either side of the flange 14.

In the example shown, the hook 22 has a generally curved shape and each of its legs 22a, 22b has a curved shape around the axis X. Each of the legs 22a, 22b has a radial orientation with respect to the axis X and is relatively flat. As can be seen in FIG. 6, at least one of the legs 22a, 22b may comprise a bearing projection 26 configured to bear on one side of the flange 14.

The projection 26 is, for example, between 0.5 and 3 mm high, and preferably of the order of 0.5-1 mm.

Advantageously, the hook 22 is configured to clamp the flange 14 axially, the projection 26 limiting the bearing surface of the leg 22a on the flange 14 and limiting the risk of damage to the flange 14 and the part 10. In addition, locating the bearing of the leg 22a on the flange at the level of the projection 26 allows to limit the thickness of the rest of the leg 22a and to give this leg 22a some flexibility in deformation so that the hook 22 can adapt to parts 10 and in particular to parts 10 having flanges of different axial thicknesses.

In the example shown, the projection 26 is located on the internal periphery of the leg 22a. This projection 26 can extend over the entire circumference of the body.

A similar bearing projection could instead or additionally be located on the leg 22b, to come into contact with the other side of the flange 14.

The two legs 22a, 22b of the hook 22 are connected by a bridge 28 which is generally curved and is configured to bear radially on the flange 14, as can be seen in FIGS. 4 and 6 in particular. It is therefore understood that the hook 22 has a curvature similar to that of the flange 14 in the example shown.

FIG. 4 also shows that the hook 22 covers the flange 14 and therefore allows to hide any defects present on the flange 14 and covered by the hook 22.

The frame 24 of the body of the tooling is connected to the hook 22, and in particular to its leg 22b, and is configured to be mounted on another portion to be checked of the part 10.

In the example shown, the frame 24 is inclined relative to the hook 22. This inclination allows it to follow the frusto-conical shape of the wall 12.

The frame 24 defines a window 30 through which an operator can view a segment of the portion of the part 10 to be inspected.

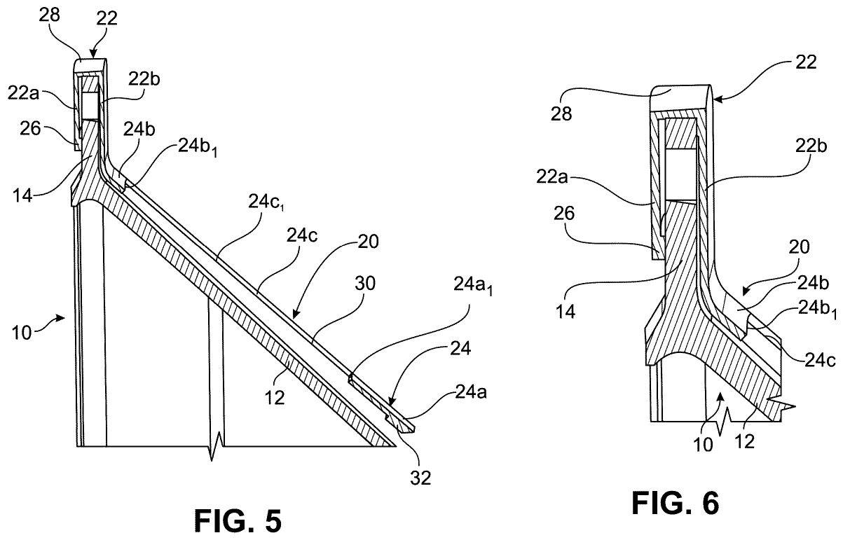

The frame 24 can also comprise a bearing projection 32 configured to bear on the portion of the part 10 to be inspected. However, as can be seen in FIG. 5, this projection 32 is not necessarily bearing on the part 10 and may be at a distance from the part. The figure also shows that the entire frame 24 can be moved away from the part when the body of the tooling is mounted on the part.

In the example shown, the projection 32 is located on the internal periphery of the frame 24. This projection 32 can extend over the entire circumference of the body.

The projection 32 is, for example, between 0.5 and 3 mm high, and preferably of the order of 0.5-1 mm.

The frame 24 comprises two curved profiles, an internal section 24a and an outer section 24b, the circumferential ends of which are connected by lateral uprights 24c. These profiles 24a, 24b and uprights 24c define the window 30 between them.

In the example shown, the internal profile 24a has a dimension, in particular R1, greater than that R2 of the external profile 24b, and greater than a circumferential thickness E1 of each of the lateral uprights 24c.

The external profile 24b is configured to cover the rest of the zone Z1 that is not covered by the hook 22. In other words, the hook 22 and the external profile 24b of the frame 24 together cover the zone Z1 of the part 10, or at least a sector of this zone Z1, as illustrated in FIG. 4.

The internal profile 24a is configured to cover a portion of the zone Z3. It is therefore understood that the window 30 which extends between the profiles 24a, 24b is located at the level of the zone Z2 and therefore enables an operator to view and control this zone Z2 or at least a sector of this zone Z2. The internal profile 24a may comprise an external edge 24a1 forming a tracing rule on the part 10. Alternatively, or as an additional characteristics, the external profile 24b may comprise an internal edge 24b1 forming a tracing rule on the part 10. The uprights 24c can also each comprise a lateral edge 24c1 forming a tracing rule on the part 10.

The invention also relates to a method for visually inspecting the part 10 by means of tooling 20 as described above.

The method comprises the steps of:
a) positioning the body of the tooling 20 on the part 10 by mounting the hook 22 on the flange 14, the two lateral legs 22a, 22b of the hook 22 being located respectively on the two sides of the flange 14, and
b) checking the part 10, and in particular the portion of the part 10 on which the body is mounted, this checking step being carried out by an operator.

With regard to step a), the body of the tooling 20 is preferably positioned so that the hook 22 axially clamps the flange 14 and bears radially on the flange 14. In the mounting position, the frame 24 can bear on or be at a distance from the part 10, as shown in FIG. 5.

The portion of the part 10 on which the body of the tooling 20 is mounted comprises:
the zone Z1, or at least a sector of this zone Z1, covered by the hook 22 and the external profile 24b of the frame, and which is therefore hidden by these elements,
the zone Z2, or at least a sector of this zone Z2, visible through the window 30 of the frame 24, and
the zone Z3, or at least a sector or the portion of this zone Z3, covered by the internal profile 24a of the frame, and which is therefore hidden by this element. It is thus understood that step b) may comprise the sub-steps of:
checking by the operator if there are marks or wear on the part 10 and which are hidden by the frame 24, and in particular by its profiles 24a, 24b; the defects located behind the profile 24a would be considered as being in the zone Z3 and therefore less problematic; the defects located behind the profile 24b would be considered as being in the zone Z1 and therefore problematic;
checking by the operator if there are marks or wear located on the part 10 which are hidden by the hook 22; the defects located behind the hook 22 would then be considered as being in the zone Z1 and therefore also problematic; and
checking by the operator if there are any marks or wear visible through the window 30; these visible defects would then be considered as being in the zone Z2 and therefore potentially problematic depending on their dimensions in particular.

To do this, the operator can, for example, detect the presence of a defect on the part 10 and then mount the body of the tooling on the part 10 to determine whether or not this defect is hidden by the tooling 20 or visible through its window 30. This allows the level of compliance of the defect to be quickly determined.

In the example shown in FIG. 8, a defect 34 is visible through the window and its position is measured by the operator at a distance L1 from the edge 24b1 and at a distance L2 from the edge 24a1. He therefore concludes that this fault is located in zone Z2.

Another way of proceeding would be to mount the body of the tooling on the part 10 and then draw lines along the edges 24a1, 24b1 of the frame 24. Once the tooling 20 has been removed, the operator can then determine where any defects are located in relation to these markings.

In step c), the method may comprise a step c) of moving the body of the tooling 20 on the part 10, by rotating the body mounted on the part 10 about the axis X.

The steps of the method a) and/or b) can be repeated after this step c).

The steps a), b) and/or c) can be repeated as many times as necessary to check the entire contour of the part 10.

The same tooling 20 can be used to inspect several parts 10, including parts 10 of different shapes and/or sizes. This is made possible, for example, by the aforementioned flexibility of the hook 22 and the fact that it is not necessary for the frame 24 of the tooling 20 to bear on the part 10 in order to be able to control it.

This solution allows in particular:
to simplify the inspection by the operators, who will no longer have to worry about how to take measurements; in fact, with the tooling 20, the operator will be able, for example, to draw lines and measure the position of a defect in relation to these lines;
to guarantee that the control requested will be compliant and identical for all the operators;
to avoid mistakes;
to make the requested control more visual, etc.

1. A tooling for visual inspecting an aircraft turbomachine part, the part having an annular shape about an axis (X) and comprising an annular attachment flange oriented in a radial direction with respect to the axis (X), the tooling comprising an integrally formed body and comprising:
a U-shaped hook configured to be mounted on said flange, the U-shaped hook having a curved shape and having a curvature configured to be similar to that of said flange, the hook comprising two lateral legs configured to be located on both sides of the flange, respectively, and
a frame connected to the hook and configured to cover a portion to be inspected of the part, the frame defining a window through which an operator can view a segment of said portion.

2. The tooling according to claim 1, wherein the two legs of the hook are connected together by a bridge that has a generally curved shape and is configured to bear radially on the flange.

3. The tooling according to claim 1, wherein at least one of said legs comprises a bearing projection configured to bear on one side of the flange.

4. The tooling according to claim 1, wherein the frame comprises a bearing projection configured to bear on said portion of the part.

5. The tooling according to claim 1, wherein the frame is inclined with respect to the hook.

6. The tooling according to claim 1, wherein the frame comprises a curved internal profile and a curved external profile, the circumferential ends of which are connected together by lateral uprights, the internal and external profiles and the uprights delimiting between them said window.

7. The tooling according to claim 6, wherein the internal profile has a dimension (R1) greater than that (R2) of the external profile, and greater than a circumferential thickness (E1) of each of the lateral uprights.

8. The tooling according to claim 1, wherein the frame comprises at least one edge forming a tracing rule on the part.

9. The tooling according to claim 1, wherein the body has a curved shape and an angular extent of between 1° and 30° about an axis, which is configured to coincide with the axis (X) of the part.

10. A method for visually inspecting an aircraft turbomachine part by means of the tooling according to claim 1, the part having an annular shape about an axis (X) and comprising an annular attachment flange that is oriented in the radial direction with respect to the axis, the method comprising the steps consisting of:
a) positioning the body of the tooling on the part by mounting the hook on the flange, the two lateral legs of the hook being located respectively on the two sides of the flange, and
b) inspecting the part, and in particular the portion of the part on which the body is mounted, this inspection step being carried out by an operator.

11. The method according to claim 10, wherein the part is a trunnion that comprises a frustoconical wall, and said flange is directed radially towards the outside and located at an external periphery of the frustoconical wall, the body of the tooling being positioned in step a) so that the frame is mounted on a portion of an external frustoconical surface of that frustoconical wall.

12. The method according to claim 10, wherein step b) comprises the sub-steps of:
checking by the operator if there are any marks or wear on the part which are hidden by the body of the tooling, and
checking by the operator if there are any marks or wear visible through the window of the tooling.

13. The method according to claim 10, the tooling, wherein the body has a curved shape and an angular extent of between 1° and 30° about an axis, which is configured to coincide with the axis (X) of the part, and at least one line is drawn on the part along one of the edges of the frame.

14. The method according to claim 10, wherein, after the steps a) and b), the method further comprises a step c) of moving the body of the tooling on the part by rotating the body mounted on the part about the axis (X) of the part, and then step b) of the method is repeated.

15. The method according to claim 14, wherein the steps b) and c) are repeated as many times as necessary so as to inspect the entire contour of the part.
